(19) United States
(12) Patent Application Publication
(10) Pub. No.: US 2023/0358392 A1
(43) Pub. Date: Nov. 9, 2023

(54) Sensitive Component Disposition and Orientation External to Elevated Thermal Envelope in Vertically Oriented Luminaire

(71) Applicant: Frank Shum, Sunnyvale, CA (US)

(72) Inventor: Frank Shum, Sunnyvale, CA (US)

(21) Appl. No.: 18/311,121

(22) Filed: May 2, 2023

Related U.S. Application Data
(60) Provisional application No. 63/364,274, filed on May 6, 2022.
(60) Provisional application No. 63/376,735, filed on Sep. 22, 2022.

(51) Int. Cl. F21V 29/10; F21V 29/15; F21V 23/00; F21V 29/77

(52) U.S. Cl. CPC F21V 29/10; F21V 29/15; F21V 23/008; F21V 29/773; F21Y 2115/10

(57) ABSTRACT

Apparatus and associated methods relate to an LED device having thermally compartmentalized enclosures. In an illustrative example, a lighting device may include an LED module and a power circuit. The power circuit, for example, may include a heat generating component (HGC) (e.g., a power transistor) and a thermally sensitive component (TSC) (e.g., a capacitor). For example, the lighting device may include a first enclosure including the HGC, and a second enclosure including the TSC. In operation, the first enclosure may be higher than the second enclosure. In some implementations, the second enclosure may be thermally isolated from the first enclosure, and physically external to the first enclosure and the LED module. For example, the second enclosure may be exposed to an ambient environment. Various embodiments may advantageously maintain the temperature of the second enclosure isolated from, and lower than, the temperature of the first enclosure.

### CROSS-REFERENCE TO RELATED APPLICATIONS

This application claims the benefit of U.S. Provisional Application Ser. No. 63/364,274, titled “Sensitive Component Disposition and Orientation External to Elevated Thermal Envelope in Vertically Oriented Luminaire,” filed by Frank Shum, on May 6, 2022.

This application incorporates the entire contents of the foregoing application(s) herein by reference.

The subject matter of this application may have common inventorship with and/or may be related to the subject matter of the following:
U.S. application Ser. No. 14/952,079, titled “LED Lighting,” filed by Frank Shum on Nov. 25, 2015, and issued as U.S. Pat. No. 9,420,644 on Aug. 16, 2016;
U.S. application Ser. No. 15/215,964, titled “LED Lighting,” filed by Frank Shum, on Jul. 21, 2016, and issued as U.S. Pat. No. 9,581,323 on Feb. 28, 2017;
European Application Serial No. EP 17832026.3, titled “LED Lighting,” filed by Frank Shum on Jan. 29, 2019;
U.S. Application Serial No. 2019-503405, titled “LED Lighting,” filed by Frank Shum on Jan. 17, 2019;
PCT Patent Application Serial No. PCT/US2017/052632, titled “LED Lighting,” filed by Frank Shum on Sep. 21, 2017;
U.S. application Ser. No. 15/407,140, titled “LED Light Re-Direction Accessory,” filed by Frank Shum on Jan. 16, 2017, and issued as U.S. Pat. No. 9,897,304 on Feb. 20, 2018;
U.S. application Ser. No. 15/880,369, titled “LED Light Re-Direction Accessory,” filed by Frank Shum on Jan. 25, 2018, and issued as U.S. Pat. No. 10,082,284 on Sep. 25, 2018;
U.S. application Ser. No. 16/130,891, titled “LED Light Re-Direction Accessory,” filed by Frank Shum on Sep. 13, 2018;
U.S. application Ser. No. 16/713,452, titled “LED Light Re-Direction Accessory,” filed by Frank Shum on Dec. 13, 2019;
U.S. application Ser. No. 16/821,791, titled “LED Light Re-Direction Accessory,” filed by Frank Shum on Mar. 17, 2020 and issued as U.S. Pat. No. 11,022,297 on Jun. 1, 2021;
U.S. application Ser. No. 17/302,029, titled “LED Light Re-Direction Accessory,” filed by Frank Shum on Apr. 21, 2021;
U.S. application Ser. No. 29/663,330, titled “LED Light Re-Direction Accessory,” filed by Frank Shum on Sep. 13, 2018;
PCT Patent Application Serial No. PCT/US16/34331, titled “LED Lighting,” filed by Frank Shum on May 26, 2016;
U.S. application Ser. No. 17/179,843, titled “Driver Incorporating a Lighting Ballast for Supplying Constant Voltage Loads,” filed by Frank Shum on Feb. 19, 2021;
U.S. Provisional Application Ser. No. 62/979,254, titled “Driver Incorporating a Lighting Ballast for Supplying Constant Voltage Loads,” filed by Frank Shum, et al., on Feb. 20, 2020;
U.S. application Ser. No. 15/968,924, titled “LIGHT DISTRIBUTION FOR PLANAR PHOTONIC COMPONENT,” filed by Frank Shum on May 2, 2018 and issued as U.S. Pat. No. 10,697,612 on Jun. 30, 2020;
U.S. application Ser. No. 17/179,843, titled “Driver Incorporating a Lighting Ballast for Supplying Constant Voltage Loads,” filed by Frank Shum, on Feb. 21, 2021 and issued as U.S. Pat. No. 11,363,691 on Jun. 14, 2022;
U.S. application Ser. No. 17/663,070, titled “Post Top LED Lamp Optics,” filed by Frank Shum, on May 12, 2022 and issued as U.S. Pat. No. 11,614,207 on Mar. 28, 2023.

This application incorporates the entire contents of the foregoing application(s) herein by reference.

### TECHNICAL FIELD

Various embodiments relate generally to temperature regulation of a light emitting electrical system.

### BACKGROUND

Light Emitting Diodes (LEDs) gained widespread popularity due to their numerous advantages over traditional lighting sources. LEDs are highly efficient, consuming much little power to produce light. In some examples, LEDs may have a long lifespan and emit less heat, making them an environmentally friendly and cost-effective lighting option. LEDs are used in a variety of applications, for example, including general lighting in homes and businesses to backlighting displays and screens.

Generally, an LED may include a semiconductor chip, a substrate to support the chip, a lens to direct the light, and a power driving circuit to control the amount of power supplied to the LED, for example. The power driving circuit may, for example, regulate the voltage and current supplied to the LED to prevent overloading and ensure optimal performance. For example, the power driving circuit may include components such as resistors, capacitors, and transistors to control the flow of electricity to the LED.

The power driving circuit may, for example, convert AC power to the DC power needed to power the LED.

### SUMMARY

Apparatus and associated methods relate to an LED device having thermally compartmentalized enclosures. In an illustrative example, a lighting device may include an LED module and a power circuit. The power circuit, for example, may include a heat generating component (HGC) (e.g., a power transistor) and a thermally sensitive component (TSC) (e.g., a capacitor). For example, the lighting device may include a first enclosure including the HGC, and a second enclosure including the TSC. In operation, the first enclosure may be higher than the second enclosure. In some implementations, the second enclosure may be thermally isolated from the first enclosure, and physically external to the first enclosure and the LED module. For example, the second enclosure may be exposed to an ambient environment. Various embodiments may advantageously maintain the temperature of the second enclosure is isolated from, and lower than, the temperature of the first enclosure.

Various embodiments may achieve one or more advantages. For example, some embodiments may advantageously isolate the first and the second enclosure by introducing an air gap. Some embodiments, for example, may advantageously isolate the first and the second enclosure by introducing a thermally insulating material. For example, some embodiments may advantageously increase heat dissipation from the second enclosure by having a majority of the second enclosure's surface exposed to ambient air. Some embodiments, for example, may advantageously allow cool air to surround the second enclosure before the first enclosure. For example, some embodiments may advantageously allow different air flows by placing the second enclosure horizontally adjacent, while remaining thermally isolated, to the first enclosure.

The details of various embodiments are set forth in the accompanying drawings and the description below. Other features and advantages will be apparent from the description and drawings, and from the claims.

### BRIEF DESCRIPTION OF THE DRAWINGS

FIG. 1A and FIG. 1B depict an exemplary Thermally Segregated Luminaire (TSL) employed in an illustrative use-case scenario.

FIG. 2A and FIG. 2B depict an exemplary TSL and an exemplary thermal envelope of the TSL in operation.

FIG. 3A and FIG. 3B depict an exemplary thermal sensitive enclosure coupled to an exemplary TSLED.

FIG. 4A and FIG. 4B depict a second embodiment of an exemplary thermal sensitive enclosure coupled to an exemplary TSL

FIG. 5A and FIG. 5B depict a third embodiment of an exemplary thermal sensitive enclosure coupled to an exemplary TSL.

FIG. 6 depicts an exemplary releasable thermal sensitive enclosure.

FIG. 7A, FIG. 7B, and FIG. 7C depict exemplary embodiments and orientations of a heat generating enclosure and a thermal sensitive enclosure in exemplary thermal sensitive component isolating electrical devices (TSCIED).

FIG. 8 is a flowchart illustrating an exemplary TSL configuration method.

Like reference symbols in the various drawings indicate like elements.

### DETAILED DESCRIPTION OF ILLUSTRATIVE EMBODIMENTS

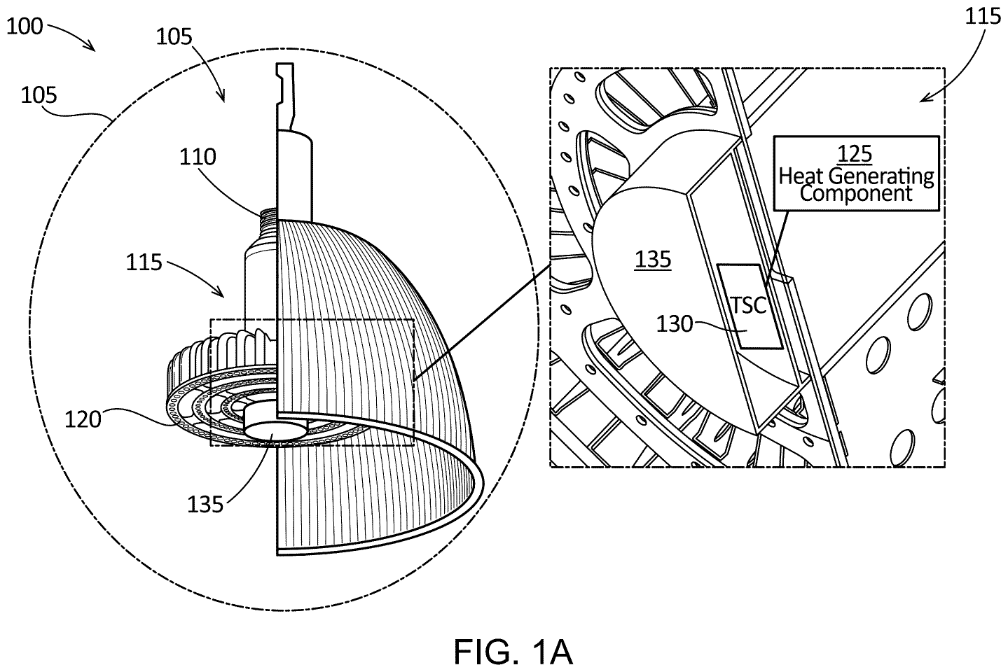

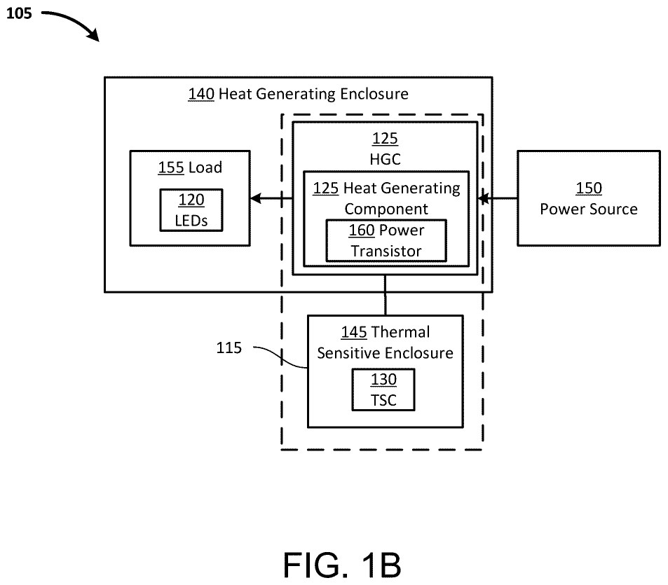

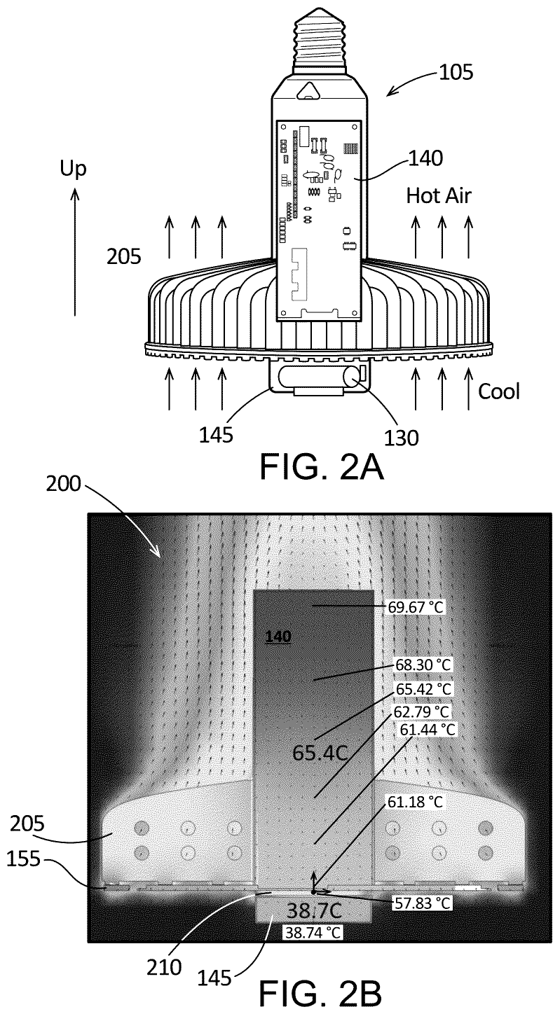

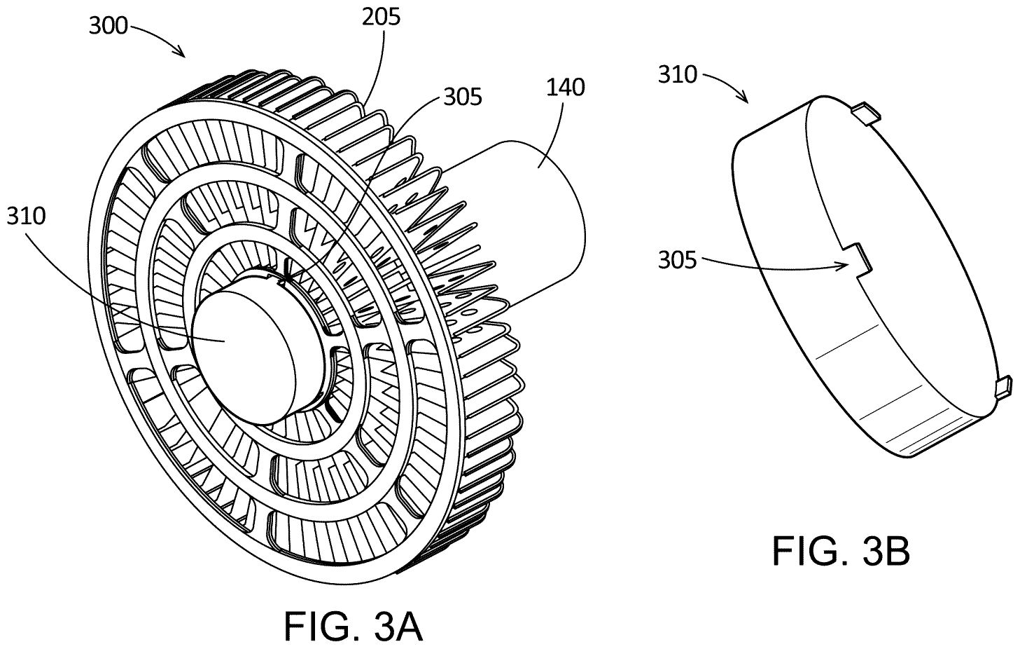

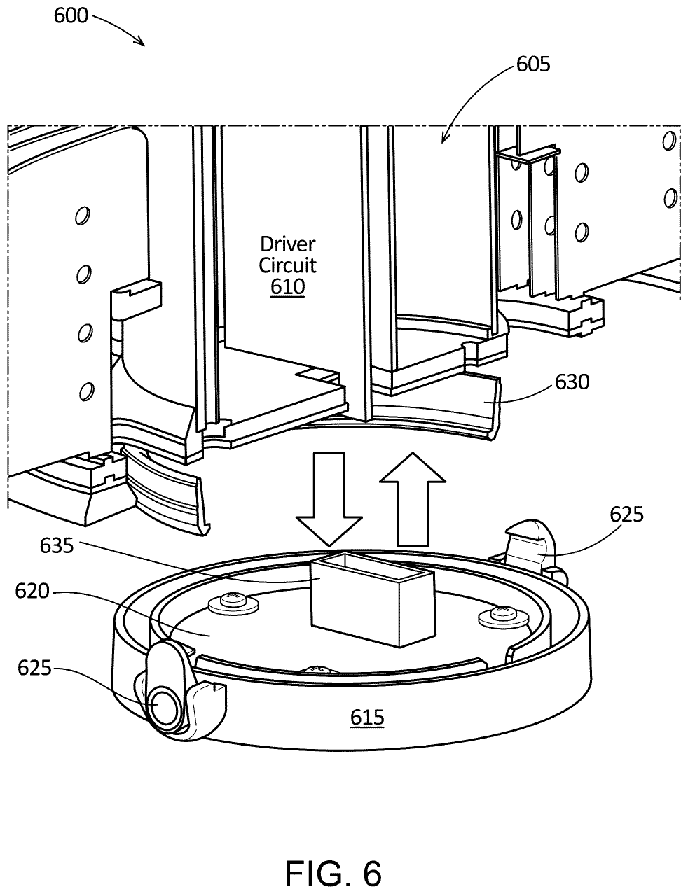

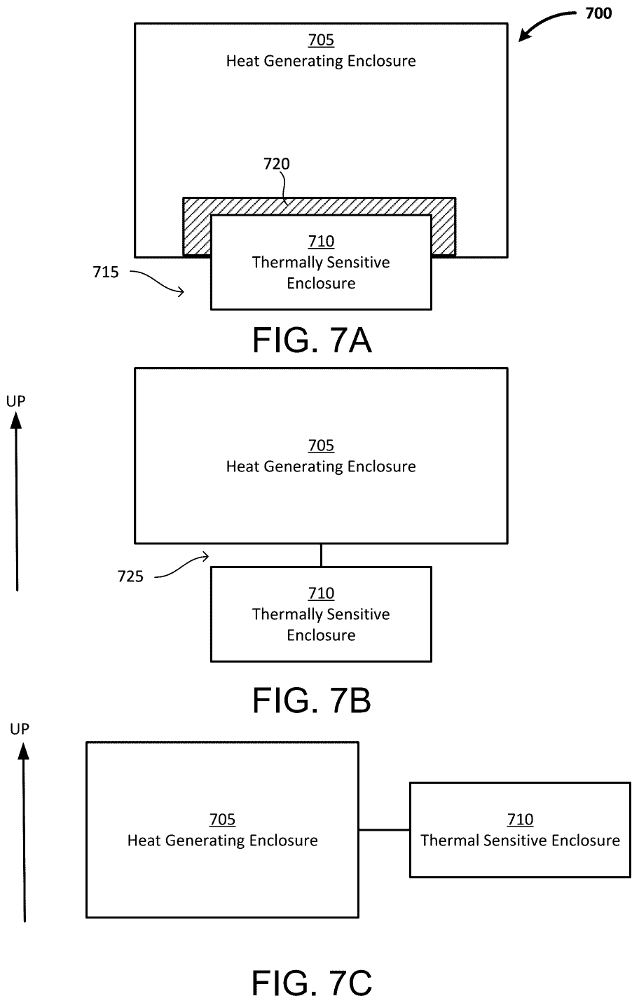

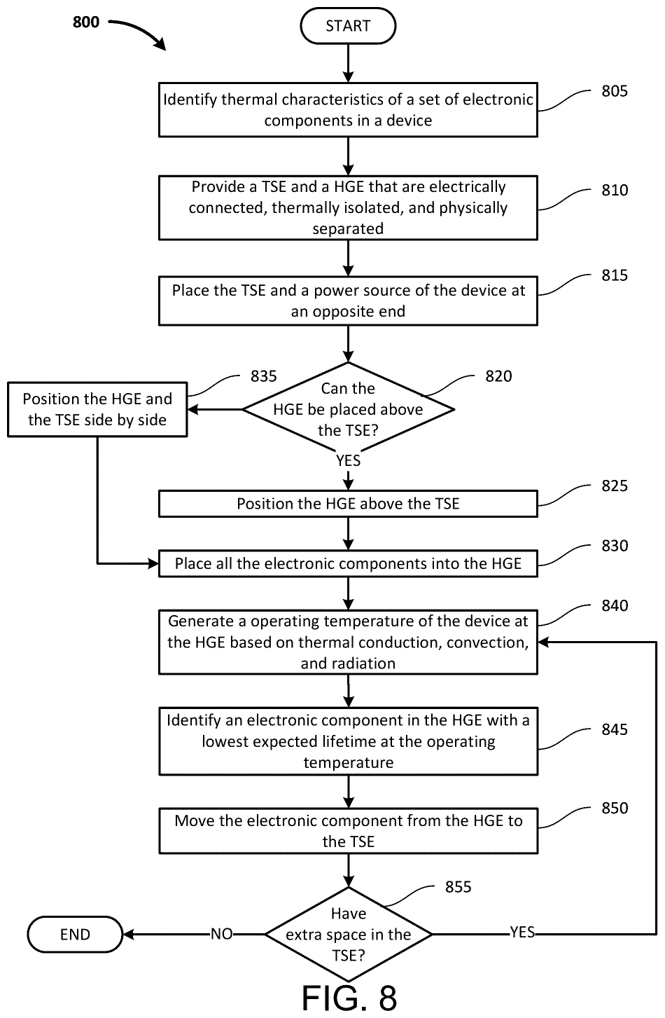

To aid understanding, this document is organized as follows. First, to help introduce discussion of various embodiments, a thermally separated luminaire (TSL) is introduced with reference to FIGS. 1A-2. Second, that introduction leads to a description with reference to FIGS. 3A-5B of some exemplary embodiments of TSL. Third, with reference to FIG. 6, a removable protruding module is described in application to exemplary TSL. Fourth, with reference to FIGS. 7A-C, the discussion turns to exemplary embodiments that illustrate various configurations of thermal sensitive component isolating electrical devices (TSCIED). Fifth, and with reference to FIG. 8, this document describes exemplary apparatus and methods useful for configuring a TSCIED. Finally, the document discusses further embodiments, exemplary applications and aspects relating to TSL.

FIG. 1A and FIG. 1B depict an exemplary Thermally Segregated Luminaire (TSL) employed in an illustrative use-case scenario. As shown in FIG. 1A, a warehouse 100 may include TSL 105. For example, the TSL 105 may receive electrical power and illuminate the warehouse 100. For example, the TSL 105 may include incandescent bulbs. For example, the TSL 105 may include fluorescent lamps. For example, the TSL 105 may include high-intensity discharge (HID) lamps. For example, the TSL 105 may include halogen lamps. For example, the TSL 105 may include induction lamps. For example, the TSL 105 may include light emitting diode (LED) devices.

The TSL 105 includes a power socket 110 and a power circuit 115. For example, the power socket 110 may be coupled to an external power source to supply power to the power circuit 115. For example, the power socket 110 may be a screw base configured to be screwed onto an electric socket of the warehouse 100. In some examples, the power socket 110 may be a power plug configured to connect an external power socket. For example, the TSL 105 may be a power LED lamp.

As shown, the power circuit 115 includes multiple rings of LEDs 120. In some implementations, the power circuit 115 may supply a regulated power to the LEDs 120. The LEDs 120 may, for example, use the supplied power to generate light.

In this example, the power circuit 115 includes a heat generating component 125 electrically coupled to a thermally sensitive component 130. For example, the heat generating component 125 may include a Metal Core Printed Circuit Board (MCPCB). For example, the heat generating component 125 may include a power transistor. For example, the heat generating component 125 may include a resistor. For example, the heat generating component 125 may include a solar inverter. For example, the heat generating component 125 may include a battery charger. For example, the heat generating component 125 may include a power supply. For example, the heat generating component 125 may include a LED driver. In a process of converting AC to DC power, for example, the transistors and the resistors of a power circuit may generate heat as they operate. As a result, managing the temperature of these components may, for example, be critical to ensure the reliable operation and long lifespan of the LED.

The thermally sensitive component 130, for example, may include a capacitor. In various examples, the thermally sensitive component 130 may include a lower working temperature tolerance than the heat generating component 125. For example, a high temperature may reduce a lifetime of the thermally sensitive component 130.

In operation, the heat generating component 125 may generate thermal energy. In various implementations, the heat generating component 125 and the thermally sensitive component 130 may be physically separated such that a temperature of the thermally sensitive component 130 may be kept at a temperature significantly lower (e.g., 5° C., 10° C., 15° C.) than the heat generating component 125 to preserve lifetime of the thermally sensitive component 130. As shown, the thermally sensitive component 130 is enclosed in a protruded enclosure 135. For example, the protruded enclosure 135 may be thermally isolated and physically external from the heat generating component 125. In some implementations, the protruded enclosure 135 may include a surface area exposed to an ambient environment to reduce temperature of the thermally sensitive component 130. Accordingly, for example, the separation of the heat generating component 125 and the thermally sensitive component 130 may advantageously improve service lift time of the TSL 105 by preserving the lifetime of the thermally sensitive component 130 against high temperature of the heat generating component 125.

FIG. 1B shows a block diagram of an exemplary TSL 105. In this example, the TSL 105 includes a heat generating enclosure 140 and a thermal sensitive enclosure 145. A power source 150 (e.g., an Alternative Current power input, a battery source) is coupled to the heat generating component 125 of the heat generating enclosure 140. The thermal sensitive enclosure 145 includes, in this example, a load 155 including the LEDs 120. The load 155 receives power from the power source 150 through the heat generating component 125 of the power circuit 115. For example, the load 155 may consume power within the heat generating enclosure 140.

In some implementations, the heat generating enclosure 140 and the thermal sensitive enclosure 145 may be separated by physical barriers. For example, the heat generating enclosure 140 and the thermal sensitive enclosure 145 may be separated by independent housing (e.g., in polycarbonate, aluminum housing, metal alloy) separated by thermal insulation and/or air. For example, the thermal sensitive enclosure 145 may include a thermal conductivity of less than 0.4 w/(M-k) to advantageously prevent building up of thermal energy into the thermal sensitive enclosure 145 through thermal conduction.

The thermal sensitive enclosure 145 enclosed the thermally sensitive component 130. For example, the thermally sensitive component 130 may include a capacitor. For example, the thermally sensitive component 130 may include at least one capacitor.

For example, the thermally sensitive component 130 may include a film type capacitor. For example, the thermally sensitive component 130 may include an electrolytic capacitor. For example, the electrolytic capacitor may include a maximum operating temperature of 30-50° C. below the heat generating component 125 to achieve a same reliability.

In some implementations, the thermally sensitive component 130 may be thermally isolated (e.g., by thermal conduction, thermal convection, thermal radiation) from thermal energy dissipated from the thermally sensitive component 130. For example, the thermally sensitive component 130 may be positioned outside of a thermal energy flow path of the heat generating component 125.

In operation, the heat generating component 125 may receive the power source 150 and supply a regulated power to the load using a power transistor 160. For example, the heat generating component 125 may generate higher heat watts (e.g., 2, 5, 10 times) then the thermally sensitive component 130.

In some implementations, while the thermal sensitive enclosure 145 is physically separated from the heat generating enclosure 140, the thermally sensitive component 130 may be electrically coupled to the heat generating component 125 to receive signals. For example, a capacitor of the heat generating component 125 may stabilize a voltage and filter out unwanted noise from a power signal received at the power circuit 115. For example, the capacitor may maintain a steady voltage to be supplied to the load 155. For example, the power circuit 115 may use the thermally sensitive component 130 to supply a regulated power to the load 155.

In some implementations, the power source 150 (e.g., the power socket 110 in FIG. 1A) and the thermal sensitive enclosure 145 (e.g., the protruded enclosure 135) may be disposed on an opposite end of the TSL 105. For example, the power socket 110 may generate substantial thermal energy in operation. For example, by placing the power socket 110 and the protruded enclosure 135 at opposite ends, heat transmission (e.g., by conduction, convection, radiation) from the power socket 110 to the thermal sensitive enclosure 145 may be minimized.

In various implementations, a lighting device may include a LED module (e.g., the LEDs 120) and a power circuit (e.g., the power circuit 115). For example, the power circuit may be operably coupled to the LED module. For example, the power circuit may supply a regulated power received from a power source (e.g., the power source 150). to the LED module. For example, the power circuit may include a heat generating component (e.g., the heat generating component 125) and a thermally sensitive component (e.g., the thermally sensitive component 130).

For example, a first enclosure (e.g., the heat generating component 125) may include the heat generating component. For example, a second enclosure may include the thermally sensitive component. For example, in operation, a temperature of the first enclosure may be higher than a temperature of the second enclosure. The second enclosure, for example, may be thermally isolated from the first enclosure. The second enclosure may be physically external to the first enclosure and the load and the second enclosure may be exposed to an ambient environment. For example, the temperature of the second enclosure may be isolated from, and lower than, the temperature of the first enclosure. In some examples, the thermal sensitive enclosure 145 may be at least 5° C. lower than the temperature of the heat generating enclosure 140. For example, the thermal sensitive enclosure 145 may be at least 10° C. lower than the temperature of the heat generating enclosure 140.

FIG. 2A and FIG. 2B depict an exemplary TSL and an exemplary thermal envelope of the TSL in operation. As shown, the TSL 105 includes a heatsink 205 attached to the heat generating enclosure 140. For example, the heatsink 205 may be used to dissipate heat from the heat generating component 125 (e.g., power electronics). Physically separated from both the heatsink 205 and the heat generating enclosure 140, in this example, the thermal sensitive enclosure 145 is positioned at a region protruding in front of the TSL 105.

In this example, the TSL 105 is placed such that the thermal sensitive enclosure 145 is at the lowest altitude of the TSL 105 (e.g., closest to the ground). For example, the thermal sensitive enclosure 145 may include protruded surfaces to be exposed to an ambient environment (e.g., to ambient air in the warehouse 100). In some implementations, the thermal sensitive enclosure 145 may be a protruding compartment having a higher surface area in contact with cool region (e.g., the ambient air in the ambient environment) than the surface area surround or in contact with the hot region (e.g., the load 155, the heat generating component 125).

In this example, the thermal sensitive enclosure 145 is physically below the heat generating enclosure 140 to allow cool ambient air to flow through the thermal sensitive enclosure 145 before the heat generating enclosure 140. Cool air, for example, may be driven upwards from a lower end of the TSL 105 towards an upper end of the TSL 105. For example, the thermally sensitive component 130 may advantageously be exposed to cool air at the protruded surfaces while being out of a convection path of the heat dissipated by the heatsink 205.

FIG. 2B shows an exemplary thermal energy distribution diagram 200 of an exemplary TSL (e.g., the TSL 105). For example, the thermal energy distribution diagram 200 may include energy dissipating from the load 155 (e.g., the LEDs 120) and the heat generating component 125 in the heat generating enclosure 140. For example, the thermal energy distribution diagram 200 may be generated as a function of conduction (e.g., by thermal contact), convection (e.g., by air flow as shown by arrows in the diagram), and/or radiation. For example, the thermal energy distribution diagram 200 may be generated with an ambient temperature at 25° C.

In some implementations, the thermal sensitive enclosure 145 may be mostly detached from the front of the heatsink. In this example, the thermal sensitive enclosure 145 may be physically separated from the heat generating enclosure 140 with an insulation gap 210. For example, the insulation gap 210 may include an insulating material (e.g., a thermally insulating foam). For example, the insulation gap 210 may include an air gap. For example, the insulation gap 210 may include a physical separation.

In some implementations, the insulation gap 210 may minimize a contact surface area between the thermal sensitive enclosure 145 to the heat generating enclosure 140. Some embodiments of mechanical attaching mechanism of the heat generating enclosure 140 to the thermal sensitive enclosure 145 are discussed with reference to FIGS. 3A-6.

As shown in the thermal energy distribution diagram 200, air may be hottest behind the luminaire. Within the heat generating enclosure 140, the temperature is the highest in the thermal energy distribution diagram 200. In this example, the thermal sensitive enclosure 145 may have 10-40° C. lower temperature than the temperature in the heat generating enclosure 140. In some examples, the lower temperature may prolong a use life of the thermally sensitive component 130 (e.g., electrolytic capacitors) 2 to 16 times longer life compared to placing them in a thermally non-isolated enclosure with the heat generating enclosure 140.

FIG. 3A and FIG. 3B depict an exemplary thermal sensitive enclosure coupled to an exemplary TSL 300. In this example, the exemplary TSL 300 includes a protruding thermal sensitive enclosure 310 that is physically separated from a heat generating enclosure 140. As shown, the protruding thermal sensitive enclosure 310 may be opened in three sides to cool inlet air and exposed in one side to hot components (e.g., the heatsink 205, the power source 150, and/or heat generating component 125).

The protruding thermal sensitive enclosure 310, for example, is attached to the heat generating enclosure 140 via small displacement elements 305. For example, the small displacement elements 305 may be 2 mm. For example, the small displacement elements 305 may be 3 mm. For example, the small displacement elements 305 may be 5 mm. In some implementations, the small displacement elements 305 may allow cool air to flow in between an air gap between the protruding thermal sensitive enclosure 310 and the heat generating enclosure 140. In some implementations, the small displacement elements 305 may advantageously separate the protruding thermal sensitive enclosure 310 and the heatsink 205 physically.

In this example, the exemplary TSL 300 includes three small displacement elements 305. For example, the protruding thermal sensitive enclosure 310 may be attached to the heat generating enclosure 140 by welding at the small displacement elements 305. For example, the protruding thermal sensitive enclosure 310 may be attached to the heat generating enclosure 140 by gluing (e.g., by applying adhesive at a mating surface of the small displacement elements 305). For example, the heat generating enclosure 140 and protruding thermal sensitive enclosure 310 may include fastening elements for coupling to each other.

As shown in FIG. 3B, the protruding thermal sensitive enclosure 310 enclosed the thermally sensitive component 130 entirely. For example, an air gap between the protruding thermal sensitive enclosure 310 and the heat generating enclosure 140 may provide thermal conduction isolation. The protruding configuration of the protruding thermal sensitive enclosure 310 may further provide a majority (e.g., more than 30%, more than 50%, more than 75%) of surface area of the protruding thermal sensitive enclosure 310 to be exposed (e.g., directly contacting at a surface of the protruding thermal sensitive enclosure 310) to cool ambient air to facilitate heat dissipation by thermal convection.

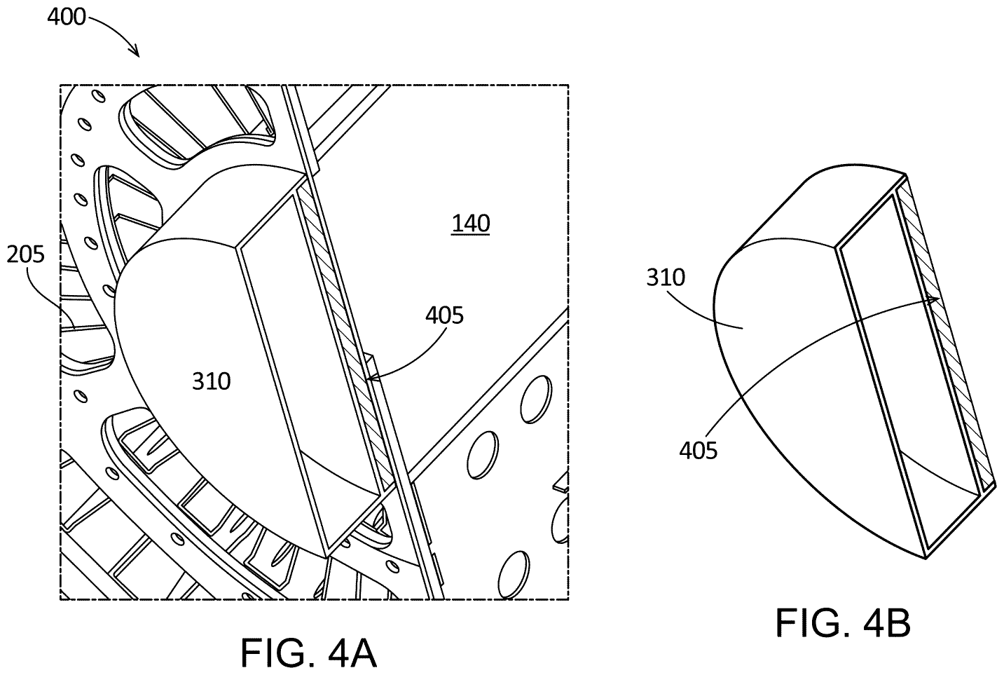

FIG. 4A and FIG. 4B depict a second embodiment of an exemplary thermal sensitive enclosure coupled to an exemplary TSL. In this example, a TSL 400 may include an insulator foam 405 between the protruding thermal sensitive enclosure 310 and the heat generating enclosure 140. For example, the insulator foam 405 may be a neoprene foam. For example, the insulator foam 405 may be a polyurethane foam. For example, the insulator foam 405 may be a silicone foam. In some examples, the insulator foam 405 may have a thermal conductivity of less than 0.05 w/(m-k). In various implementations, the insulator foam 405 may advantageously prevent thermal conduction from the heatsink 205 and the heat generating enclosure 140 to the protruding thermal sensitive enclosure 310. In some examples, the insulator foam 405 may include adhesive to maintain a structural stability of the protruding thermal sensitive enclosure 310.

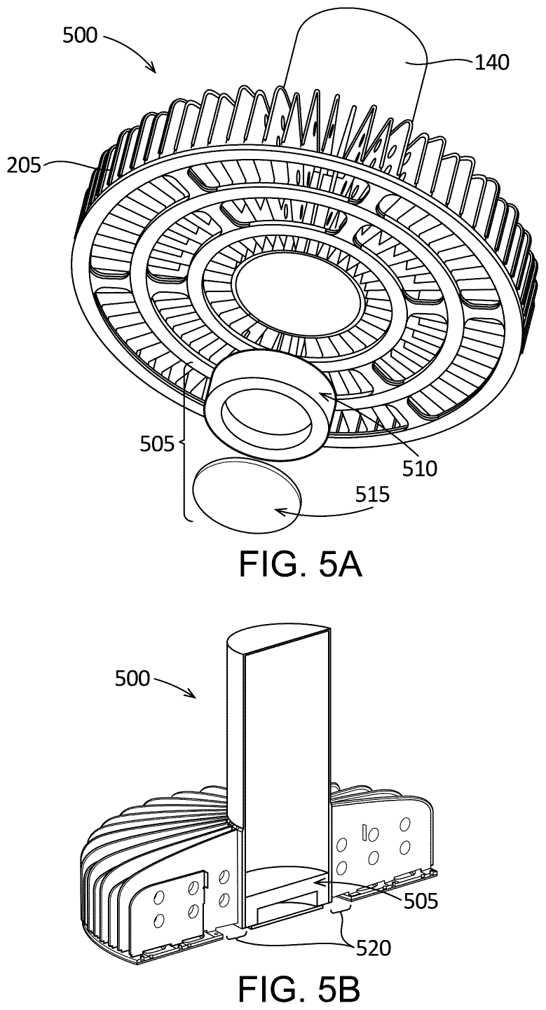

FIG. 5A and FIG. 5B depict a third embodiment of an exemplary thermal sensitive enclosure coupled to an exemplary TSL. In this example, a TSL 500 includes an isolated front thermal sensitive enclosure (IFTSE 505). The IFTSE 505 includes a thermal isolation wall housing 510 on three sides (wall and ceiling) to provide thermal isolation from the heatsink 205, the power source 150, and the heat generating enclosure 140, and a conductive lid 515 to provide a thermally conductive path to cool inlet air.

As an illustrative example, the thermally sensitive component 130 may be located in the thermal isolation wall housing 510. For example, the IFTSE 505 may be insulated on all sides facing a hot region (including the heat generating enclosure 140, and the power source 150) and the heatsink 205. Also, on one side, the IFTSE 505 may be in contact with cool ambient air, for example. As shown in FIG. 5B, the conductive lid 515 is thermally isolated from the hot region by a gap 520 while providing a thermally connective path to cool ambient air. In some examples, as a result, the IFTSE 505 may advantageously be 10° C. cooler than the hot region.

FIG. 6 depicts an exemplary releasable thermal sensitive enclosure. As shown, a luminaire 600 may include a heat generating enclosure 605 that includes a driver circuit 610. For example, there may be a MCPCB. The heat generating enclosure 605 is releasably coupled to a removable protruding module 615. For example, the removable protruding module 615 may protrude in front of the luminaire 600.

In some implementations, the removable protruding module 615 may enclose thermally sensitive components in a circuit 620. For example, the circuit 620 may include an electrolytic capacitor.

As shown, the removable protruding module 615 may be releasably coupled to the driver circuit 610 using a pair of fasteners 625. For example, the removable protruding module 615 may snap fit onto a coupling element 630 of the luminaire 600 using the fasteners 625. For example, the removable protruding module 615 may advantageously allow the thermally sensitive components (e.g., the electrolytic capacitor) inside the module to be replaced with a new module at end of life. For example, costly replacement of the luminaire 600 entirely and/or complicated replacement procedures may advantageously be reduced.

In some implementations, the removable protruding module 615 may be physically separated and thermally isolated from the driver circuit 610. For example, the temperature of the removable protruding module 615 is lower than the temperature of the driver circuit 610 in operation.

The driver circuit 610 is electrically coupled to the driver circuit 610 using an electrical port 635. For example, the removable protruding module 615 may receive from the electrical port 635 a power supply (e.g., a 3.3 V power input, a 12 V power input) and a ground reference signal. In some implementations, the circuit 620 may include control circuitry. For example, the control circuitry may include thermally sensitive components (e.g., control integrated circuits (ICs)). For example, the circuit 620 may transmit a dimming control signal (e.g., 0-10V dimming control signals) to the removable protruding module 615. For example, the circuit 620 may transmit a pulse width modulation (PWM) control signal to the removable protruding module 615.

To the Luminaire driver: For example, the circuit 620 may transmit a remotely received control signal (e.g., from a remote control/mobile app) to the removable protruding module 615 using a Universal Asynchronous Receiver-Transmitter (UART) Serial Communications interface.

FIG. 7A, FIG. 7B, and FIG. 7C depict exemplary embodiments and orientations of a heat generating enclosure and a thermal sensitive enclosure in exemplary thermal sensitive component isolating electrical devices (TSCIED). For example, the TSCIEDs may be a TSL. For example, the TSCIED may be an electronic appliance that may be prone to failure due to thermal sensitivity of their internal electronics (e.g., a computer processor, a battery charger, an audio amplifier, an Organic LED display, a solar panel charging controller)

As shown in FIG. 7A, a TSCIED 700 includes a heat generating enclosure 705 and a thermally sensitive enclosure 710. For example, the heat generating enclosure 705 may include electronics with a higher operation temperature than an operation temperature of electronics enclosed in the thermally sensitive enclosure 710. As shown, the thermally sensitive enclosure 710 includes a majority of surface areas exposed to an ambient environment 715. In this example, the thermally sensitive enclosure 710 is isolated from the heat generating enclosure 705 by an isolation layer 720 (e.g., the insulation gap 210, the insulator foam 405). In some implementations, the thermally sensitive enclosure 710 may be physically separated from the heat generating enclosure 705. For example, components enclosed in the thermally sensitive enclosure 710 may advantageously be maintained at a lower temperature than the heat generating enclosure 705.

As shown in FIG. 7B, the heat generating enclosure 705 and the thermally sensitive enclosure 710 are separated by an air gap 725. For example, the air gap 725 may thermally isolate the thermally sensitive enclosure 710 from the heat generating enclosure 705. In some implementations, the thermally sensitive enclosure 710 may be surrounded by ambient air. For example, a flow of the ambient air may further reduce the temperature of the thermally sensitive enclosure 710. As shown, the heat generating enclosure 705 is arranged to be at a position higher than the thermally sensitive enclosure 710. For example, the heat generating enclosure 705 may be positioned, in operation, at a height greater or equal to the thermally sensitive enclosure 710. In some implementations, this configuration may advantageously reduce thermal convection from the heat generating enclosure 705 to the thermally sensitive enclosure 710 because the hot air induced by the heat generating enclosure 705 may flow upward away from the thermally sensitive enclosure 710.

As shown in FIG. 7C, the heat generating enclosure 705 and the thermally sensitive enclosure 710 are configured “side by side”. For example, the heat generating enclosure 705 and the thermally sensitive enclosure 710 may be coupled to the TSCIED 700 on a horizontal plane. For example, the heat generating enclosure 705 may be at an equal or higher position than the thermally sensitive enclosure 710 in operation. For example, the heat generating enclosure 705 and the thermally sensitive enclosure 710 may be surrounded by ambient air. Because air flows from bottom to top, the thermally sensitive enclosure 710 and the heat generating enclosure 705 may receive substantially different air flows. For example, the different air flows may dissipate thermal energy differently (e.g., subjected to independent air flows) such that the temperature of the thermally sensitive enclosure 710 may be isolated from the thermal energy generated at the heat generating enclosure 705.

FIG. 8 is a flowchart illustrating an exemplary TSL configuration method 800. For example, an engineer may perform the method 800 using a simulation software executed on a computing device to design the TSL 105 or the TSCIED 700. In this example, the method 800 begins in step 805 when thermal characteristics of a set of electronic components in a device are identified. For example, the engineer may input thermal characteristics of each required electronic component for the device, including maximum operating temperature and heat generation characteristics, into the simulation software.

In step 810, a thermally sensitive enclosure (TSE) and a heat generating enclosure (HGE) are provided. The TSE and the HGE are electrically connected, thermally isolated, and physically separated. For example, the heat generating enclosure 140 and the thermal sensitive enclosure 145 may be provided. Next, the TSE and a power source may be placed at an opposite end of the device in step 815. For example, the thermal sensitive enclosure 145 may be placed at an opposite end of the power socket 110 to reduce heat transferred from the power socket 110 to the thermal sensitive enclosure 145 by conduction and convection.

In a decision point 820, it is determined whether the HGE can be placed above the TSE. For example, the thermal sensitive enclosure 145 may be placed above the heat generating enclosure 140 only if a size of a device housing allows the separation. If the HGE can be placed above the TSE, the HGE is positioned above the TSE in step 825. For example, the heat generating enclosure 140 is placed above the thermal sensitive enclosure 145 in operation as shown in FIG. 2. Next, in step 830, all the electronic components are placed into the HGE in step 830. In the decision point 820, if the HGE cannot be placed above the TSE, in step 835, the HE and the TSE are positioned side by side (e.g., as shown in FIG. 7C).

After placement of the electronic components, in step 840, an operating temperature of the device at the HGE based on thermal conduction, convection, and radiation is generated. For example, the simulation software may generate data similar to the thermal energy distribution diagram 200. Next, an electronic component in the HGE with a lowest expected lifetime at the operating temperature is identified in step 845. For example, the engineer may select the component based on the thermal characteristics.

In step 850, the electronic component is moved from the HGE to the TSE. In decision point 855, it is determined whether there is extra space in the TSE. For example, the circuit 620 may have limited space for placing the thermally sensitive component 130. If there is extra space in the TSE, the step 840 is repeated. If there is no extra space in the TSE, the method 800 ends.

Although various embodiments have been described with reference to the figures, other embodiments are possible.

In various implementations, the power circuit 115 may include a Power Factor Correction (PFC), inductor-converter, and/or synchronized bridge topology to advantageously realize a single electrolytic capacitor design. For example, the combination of these topologies may advantageously allow for a single electrolytic capacitor design to reduce fault rate and, for example, reduce costs.

Although an exemplary system has been described with reference to FIGS. 1A-B, other implementations may be deployed in other industrial, scientific, medical, commercial, and/or residential applications.

Temporary auxiliary energy inputs may be received, for example, from chargeable or single use batteries, which may enable use in portable or remote applications. Some embodiments may operate with other DC voltage sources, such as 9V batteries, for example. Alternating current (AC) inputs, which may be provided, for example from a 50/60 Hz power port, or from a portable electric generator, may be received via a rectifier and appropriate scaling. Provision for AC (e.g., sine wave, square wave, triangular wave) inputs may include a line frequency transformer to provide voltage step-up, voltage step-down, and/or isolation.

Although particular features of an architecture have been described, other features may be incorporated to improve performance. Other hardware and software may be provided to perform operations, such as network or other communications using one or more protocols, wireless (e.g., infrared) communications, stored operational energy and power supplies (e.g., batteries), switching and/or linear power supply circuits, software maintenance (e.g., self-test, upgrades), and the like. One or more communication interfaces may be provided in support of data storage and related operations.

Suitable processors for the execution of a program of instructions include, by way of example, both general and special purpose microprocessors, which may include a single processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and CD-ROM and DVD-ROM disks. The processor and the memory can be supplemented by, or incorporated in, ASICs (application-specific integrated circuits).

In various embodiments, the computer system may include Internet of Things (IoT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

Various examples of modules may be implemented using circuitry, including various electronic hardware. By way of example and not limitation, the hardware may include transistors, resistors, capacitors, switches, integrated circuits, other modules, or some combination thereof. In various examples, the modules may include analog logic, digital logic, discrete components, traces and/or memory circuits fabricated on a silicon substrate including various integrated circuits (e.g., FPGAs, ASICs), or some combination thereof. In some embodiments, the module(s) may involve execution of preprogrammed instructions, software executed by a processor, or some combination thereof. For example, various modules may involve both hardware and software.

In an illustrative aspect, a lighting device may, for example, include a light emitting diode (LED) module. The lighting device may, for example, include a power circuit operably coupled to the LED module. The power circuit may, for example, include configurations to supply a regulated power received from a power source to the LED module. The power circuit may, for example, include a heat generating component. The generating component may, for example, include a power transistor. The power circuit may, for example, include a thermally sensitive component. The thermally sensitive component may, for example, include a capacitor. The power circuit may, for example, include a first enclosure. The first enclosure may, for example, include heat generating components. The power circuit may, for example, include a second enclosure. The second enclosure may, for example, include the heat generating component.

The first enclosure and the second enclosure may, for example, be configured such that, in operation of the LED module include a temperature of the first enclosure that is higher than a temperature of the second enclosure. The second enclosure may, for example, be thermally isolated from the first enclosure. The second enclosure may, for example, be physically external to the first enclosure and the LED module. The second enclosure may, for example, be exposed to an ambient environment. Accordingly, for example, the first enclosure and the second enclosure may be configured such that the temperature of the second enclosure may be isolated from, and lower than, the temperature of the first enclosure.

The lighting device may further include a thermal insulating material. The first enclosure and the second enclosure may, for example, include separation by a layer of the thermal insulating material.

The lighting device may further include a second enclosure that may, for example, releasably coupled to the power circuit.

The lighting device may further include a second enclosure including at least 30% of surface area directly exposed to the ambient environment.

The lighting device may, for example, include the ambient environment that includes air.

The first enclosure and the second enclosure may, for example, be physically configured and separated such that, in operation of the lighting device, the first enclosure may be positioned at a height greater or equal to a height of the second enclosure.

The first enclosure and the second enclosure may, for example, be coupled to the LED module on a horizontal plane, such that the first enclosure and the second enclosure may, for example, be subjected to independent air flows.

The lighting device may, for example, include a heatsink. The heatsink may, for example, be thermally coupled to the first enclosure. The heatsink may, for example, be thermally separated from the second enclosure.

In an illustrative aspect, a thermal energy dissipating electronic apparatus may, for example, include a load. The apparatus may, for example, include a power circuit. The power circuit may, for example, be operably coupled to the load. The power circuit may, for example, be configured to supply a regulated power received from a power source to the load. The power circuit may, for example, include a heat generating component. The power circuit may, for example, include a thermally sensitive component. The power circuit may, for example, include a first enclosure. The first enclosure may, for example, include the heat generating component. The power circuit may, for example, include a second enclosure. The second enclosure may, for example, include the thermally sensitive component.

At least the first enclosure and the second enclosure may, for example, include configurations such that, in operation of the load a temperature of the first enclosure may be higher than a temperature of the second enclosure. The configurations may, for example, include the second enclosure being thermally isolated from the first enclosure. The configurations may, for example, include the second enclosure being physically external to the first enclosure and the load. The second enclosure may, for example, be exposed to an ambient environment. Accordingly, for example, at least the first enclosure and the second enclosure may be configured such that the temperature of the second enclosure may be isolated from, and lower than, the temperature of the first enclosure.

The thermal energy dissipating electronic apparatus may, for example, include configurations where the second enclosure includes at least 30% of surface area directly exposed to the ambient environment.

The thermal energy dissipating electronic apparatus may, for example, include configurations where the ambient environment includes air.

The thermal energy dissipating electronic apparatus includes configurations where the first enclosure and the second enclosure are separated by a layer of solid insulation.

The thermal energy dissipating electronic apparatus includes configurations in operation, where the first enclosure and the second enclosure may, for example, be physically configured. The first and second enclosure may be separated such that a height of the first enclosure may, for example, be equal or greater than a height of the second enclosure.

The thermal energy dissipating electronic apparatus may, for example, include configurations where the first enclosure and the second enclosure may be coupled to the power circuit on a horizontal plane, such that the first enclosure and the second enclosure may be subjected to independent air flows.

The thermal energy dissipating electronic apparatus may, for example, include configurations where the load includes a light emitting diode module.

The thermal energy dissipating electronic apparatus may, for example, include configurations where the thermally sensitive component includes a capacitor.

The thermal energy dissipating electronic apparatus may, for example, include the heat generating component that may include a power transistor.

In an illustrative aspect, a thermally sensitive electronic device may, for example, include a power source. The device may, for example, include a power circuit operably coupled to the power source. The power circuit may, for example, include a heat generating component. The power circuit may, for example, include a thermally sensitive component.

The device may, for example, include a load operably coupled to the power circuit to receive power from the power source through the power circuit. The device may, for example, include a first enclosure. The first enclosure may, for example, include the heat generating component. The device may, for example, include a second enclosure. The second enclosure may, for example, include the thermally sensitive component. At least the first enclosure and the second enclosure may, for example, be configured such that, in operation of the load a temperature of the first enclosure may be higher than a temperature of the second enclosure. In operation the second enclosure may, for example, be thermally isolated from the first enclosure. In operation, the second enclosure and the power source may, for example, be disposed on opposite ends of the thermally sensitive electronic device. In operation, the second enclosure may, for example, be exposed to an ambient environment such that the temperature of the second enclosure may be isolated from, and lower than, the temperature of the first enclosure.

The thermally sensitive electronic device may, for example, include configurations where the second enclosure includes at least 30% of surface area directly exposed to the ambient environment.

The thermally sensitive electronic device may, for example, include configurations where the ambient environment comprises air.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A lighting device comprising:
a light emitting diode (LED) module;
a power circuit operably coupled to the LED module, wherein the power circuit is configured to supply a regulated power received from a power source to the LED module, wherein the power circuit comprises:
a heat generating component comprising a power transistor; and,
a thermally sensitive component comprising a capacitor;
a first enclosure comprises the heat generating component; and,
a second enclosure comprises the thermally sensitive component,
wherein first enclosure and the second enclosure are configured such that, in operation of the LED module:
a temperature of the first enclosure is higher than a temperature of the second enclosure,
the second enclosure is thermally isolated from the first enclosure,
the second enclosure is physically external to the first enclosure and the LED module, and,
the second enclosure is exposed to an ambient environment such that the temperature of the second enclosure is isolated from, and lower than, the temperature of the first enclosure.

2. The lighting device of claim 1, further comprises a thermal insulating material, wherein the first enclosure and the second enclosure are separated by a layer of the thermal insulating material.

3. The lighting device of claim 1, wherein the second enclosure is releasably coupled to the power circuit.

4. The lighting device of claim 1, wherein the second enclosure comprises at least 30% of surface area directly exposed to the ambient environment.

5. The lighting device of claim 1, wherein the ambient environment comprises air.

6. The lighting device of claim 1, wherein, in operation, the first enclosure and the second enclosure are physically configured and separated such that, in operation, the first enclosure is positioned at a height greater or equal to a height of the second enclosure.

7. The lighting device of claim 1, wherein the first enclosure and the second enclosure are coupled to the LED module on a horizontal plane, such that the first enclosure and the second enclosure are subjected to independent air flows.

8. The lighting device of claim 1, further comprising a heatsink, wherein the heatsink is thermally coupled to the first enclosure, and thermally separated from the second enclosure.

9. A thermal energy dissipating electronic apparatus comprising:
a load;
a power circuit operably coupled to the load, wherein the power circuit is configured to supply a regulated power received from a power source to the load, wherein the power circuit comprises:
a heat generating component; and,
a thermally sensitive component;
a first enclosure comprises the heat generating component; and,
a second enclosure comprises the thermally sensitive component,
wherein, at least the first enclosure and the second enclosure are configured such that, in operation of the load:
a temperature of the first enclosure is higher than a temperature of the second enclosure,
the second enclosure is thermally isolated from the first enclosure,
the second enclosure is physically external to the first enclosure and the load, and,
the second enclosure is exposed to an ambient environment such that the temperature of the second enclosure is isolated from, and lower than, the temperature of the first enclosure.

10. The thermal energy dissipating electronic apparatus of claim 9, wherein the second enclosure comprises at least 30% of surface area directly exposed to the ambient environment.

11. The thermal energy dissipating electronic apparatus of claim 9, wherein the ambient environment comprises air.

12. The thermal energy dissipating electronic apparatus of claim 9, wherein the first enclosure and the second enclosure are separated by a layer of solid insulation.

13. The thermal energy dissipating electronic apparatus of claim 9, wherein, in operation, the first enclosure and the second enclosure are physically configured and separated such that a height of the first enclosure is equal or greater than a height of the second enclosure.

14. The thermal energy dissipating electronic apparatus of claim 9, wherein the first enclosure and the second enclosure are coupled to the power circuit on a horizontal plane, such that the first enclosure and the second enclosure are subjected to independent air flows.

15. The thermal energy dissipating electronic apparatus of claim 9, wherein the load comprises a light emitting diode module.

16. The thermal energy dissipating electronic apparatus of claim 9, wherein the thermally sensitive component comprises a capacitor.

17. The thermal energy dissipating electronic apparatus of claim 9, wherein the heat generating component comprises a power transistor.

18. A thermally sensitive electronic device comprising:
a power source;
a power circuit operably coupled to the power source, wherein the power circuit comprises:
a heat generating component; and,
a thermally sensitive component;
a load operably coupled to the power circuit to receive power from the power source through the power circuit;
a first enclosure comprising the heat generating component; and,
a second enclosure comprising the thermally sensitive component,
wherein, at least the first enclosure and the second enclosure are configured such that, in operation of the load:
a temperature of the first enclosure is higher than a temperature of the second enclosure,
the second enclosure is thermally isolated from the first enclosure,
the second enclosure and the power source are disposed on an opposite ends of the thermally sensitive electronic device, and,
the second enclosure is exposed to an ambient environment such that the temperature of the second enclosure is isolated from, and lower than, the temperature of the first enclosure.

19. The thermally sensitive electronic device of claim 18, wherein the second enclosure comprises at least 30% of surface area directly exposed to the ambient environment.

20. The thermally sensitive electronic device of claim 18, wherein the ambient environment comprises air.
